(19) United States
(12) Patent Application Publication
(10) Pub. No.: US 2015/0219895 A1
(43) Pub. Date: Aug. 6, 2015

(54) PRISMATIC CORRECTING LENS

(71) Applicant: BAE SYSTEMS PLC, London (GB)

(72) Inventors: Lesile Charles Laycock, Chelmsford (GB); Christopher Stace, Filton (GB)

(73) Assignee: BAE SYSTEMS plc, London (GB)

(21) Appl. No.: 14/430,300

(22) PCT Filed: Oct. 15, 2013
(86) PCT No.: PCT/GB2013/052682

§ 371 Date: Mar. 23, 2015

(30) Foreign Application Priority Data
Oct. 15, 2012 (GB) 1218436.2

(51) Int. Cl. G02B 27/01; G02B 3/12; G02B 3/00

(52) U.S. Cl. CPC G02B 27/0101; G02B 3/0081; G02B 3/12; G02B 2027/011; G02B 2027/0196

(57) ABSTRACT

The following invention relates to an improved correcting lens for head up displays (HUDs) particularly to Liquid Crystal Display modules for use with a Head Up Display (HUD) device.

The correcting lens is preferably selected from a compound prismatic lens, wherein the lens may be either a positive or negative lens, in optical connection with a prism, provided that the two optics have different dispersion functions.

The following invention relates to an improved correcting lens for head up displays (HUDs) particularly to Liquid Crystal Display modules for use with a Head Up Display (HUD) device.

Before the present invention is described in further detail, it is to be understood that the invention is not limited to the particular embodiments described, as such may, of course, vary. It is also to be understood that the terminology used herein is for the purpose of describing particular embodiments only, and is not intended to be limiting, since the scope of the present invention will be limited only by the appended claims.

According to a first aspect of the invention there is provided a display device for vehicles comprising,

at least one display, which provides system information that is to be displayed to a user,

a partially reflecting combiner, which magnifies the system information from the display, and provides a virtual image of said display,

wherein a distortion correcting lens is located between the display and said partially reflecting combiner

The partially reflective combiner may be a stand alone device, or may be a windscreen in a vehicle vessel or craft. Projection of the image directly onto a windscreen may require specific alignment of the display to ensure that the virtual images appear in the eye line of the user. Preferably the partially reflecting combiner is a separate optic which is deployed when required, in a preferred arrangement the combiner is negative meniscus lens.

The partially reflective combiner may have a thickness (ΔU) in the range of from 2 mm to 6 mm, preferably in the range of from 3 mm to 5 mm. The combiner may be selected from any material which has a high optical transmission in the visible region, typically 400-800 nm, such as, for example glass, polycarbonate or PMMA (polymethyl methacrylate), preferably the refractive index (n) is in the range of from 1.30 to 1.80, more preferably 1.45 to 1.65.

The surfaces of the combiner may include one or more of a texture, coating, dye, light emitting layer, preferably an optically smooth finish. The radius of curvature of the combiner may be in the range of from 300 mm to 1000 mm, preferably of from 400 mm to 700 mm. The combiner may comprise an anti reflective coating, which may be selected from any spectrally active coating or multiple thin films and may comprise, such as, for example broad or narrow band filters, comprising dyes, reflective notch films, such as, for example rugate thin films, diffraction gratings, as known in the art

The user may be a person or more specifically the eye-line or line of sight of the person.

The at least one display may be selected from any output means such as, for example CRT, LCD, LED, OLED, projection, laser, liquid crystal on silicon (LCOS) device, such LCOS devices being illuminated by narrowband red, green and blue LED sources. The display will typically be illuminated by a backlight.

The user will view the virtual image but will experience different eye positions to the left and right of the centre of the display at the current position of the head some 800 mm away from the combiner. The user's normal eye positions are approximately at plus and minus 37.5 mm and the distortions introduced by the optics may make the images look quite different. Although the brain can compensate for minor distortions, it may cause unwanted eye strain if the display is used for a long length of time. One of the simplest ways of reducing the apparent distortion in the image is to tilt the display slightly forwards. Tilting the display ensures that no chromatic aberration is introduced into the image. However, it is unlikely that tilting the display will be convenient in most situations as HUD's may typically be incorporated into vehicle, vessels or crafts, where storage space is at premium, hence it will be desirable to have such systems substantially flush with the dashboard or control panels on said platforms. Furthermore tilting the display may cause unwanted reflections from interior surfaces.

In a preferred arrangement the distortion correcting lens may be selected from a tilted prism, a tilted negative focal length lens and a compound prismatic lens.

In a highly preferred arrangement the correcting lens is a compound prismatic lens, which comprises a lens and prism.

In a preferred arrangement the lens and prism are selected from materials with different dispersion functions, this has been shown to reduce chromatic aberration and provide a reduction in the distortion of the virtual image. The use of just a prism without a lens or a tilted lens without a prism, has provided a means of reducing distortion, but both introduce a degree of chromatic aberration.

The compound prismatic lens may be manufactured by any known technique, such as, for example by abutting two separate optical components together, namely mating together a separate lens and prism, or by preparing a single optic with a variable refractive index, or variable dispersion, such as, for example doping glass/plastics to provide a graded index lens. There are many known techniques for preparing gradient filled glass, plastics and polymers. The lens and prism must be optically connected.

The lens may be selected from either a positive or negative focal length lens. The Abbe number of the lens V_{L} and the prism V_{P}, are selected wherein V_{L}<V_{P}, preferably the lens has a high dispersion value and the prism has a low dispersion value.

The chromic aberration is reduced by selecting the lens and prism such that they have different dispersion values, a simple means of achieving this is to select the lens and prism from different materials, such as for example, materials independently selected from glass or plastic or polymers.

Preferably the effective focal length of the compound prismatic lens is in the range of from −100 to 1000. Preferably, the apex angle of the prism is in the range of from 10 to 30°.

In further arrangement there may be at least one fluidic lens located between the distortion correcting lens and said partially reflecting combiner, to provide an active virtual image. The active virtual image may be preferably projected at a distance in the range of from 500 mm to 100 m, such that the virtual image appears outside the vehicle, and is able to be placed at a position which coincides with an actual feature in the landscape viewed through a windscreen. The landscape may be any terrain, ocean or even the sky, and the feature is some recognisable aspect of the landscape. The feature may be part of a road network, such as a turning, junction, local hazards or it may be routes pathways across off-road terrains, to provide guidance to preferred pathways or routes to avoid hazards.

According to a further aspect of the invention there is provided a compound prismatic lens for providing chromatic aberration correction comprising a lens and prism, wherein said lens and prism are selected from materials with different dispersion functions.

According to a further aspect of the invention there is provided a method of reducing keyhole distortion and chromatic aberration of a displayed image, particularly in a HUD, comprising the steps of locating a compound prismatic lens for providing chromatic aberration correction comprising a lens and prism, wherein said lens and prism are selected from materials with different dispersion functions, between a display and the partially reflective combiner.

The at least one display and second display, when present, may provide an output from the at least one system information, such as, for example the vehicles original on board display panel (i.e. dashboard), an OEM or add-on entertainment system, navigation system or communication system. It may be desirable as a retro fit option, to provide a virtual image of the existing vehicle dashboard by using a video camera to capture real time output from the vehicle dashboard and so provide an image on the display panel, and hence to provide a virtual image via the partially reflective combiner. It may be desirable to provide further information from an external source i.e. traffic information or system information from at least two system information sources, the system information may then be overlaid or provided as two discrete messages, typically a warning secondary virtual image.

The use of a prism without a lens achieves a similar effect to tilting the display. In one particular embodiment a prism a centre thickness in the range of from 2 to 20 mm, preferably 3 to 7 mm; and has an apex angle in the range of from 5 to 25 degrees, preferably 10 to 14 degrees. The top of the prism may tilted forwards towards the combiner in the range of 10 to 17°, more preferably 13 to 15°. The prism may be made of N-BK7 glass. However, the prism introduces chromatic aberration to the system. Other lower dispersion glasses could be used to reduce the chromatic aberration.

The use of a tilted negative focal length lens without a prism achieves a similar effect to tilting the display or using a prism, and with a reduced chromatic aberration. The tilted lens without a prism may have a centre thickness in the range of 1 to 15 mm, preferably 1 to 4 mm, and a focal length in the range of from −1000 to −100 mm, preferably −900 to −700 mm. The titled lens top may be tilted forwards in the range of from 10 to 30 degrees, preferably 18 to 22 degrees.

An embodiment of the invention will now be described by way of example only and with reference to the accompanying drawings of which:

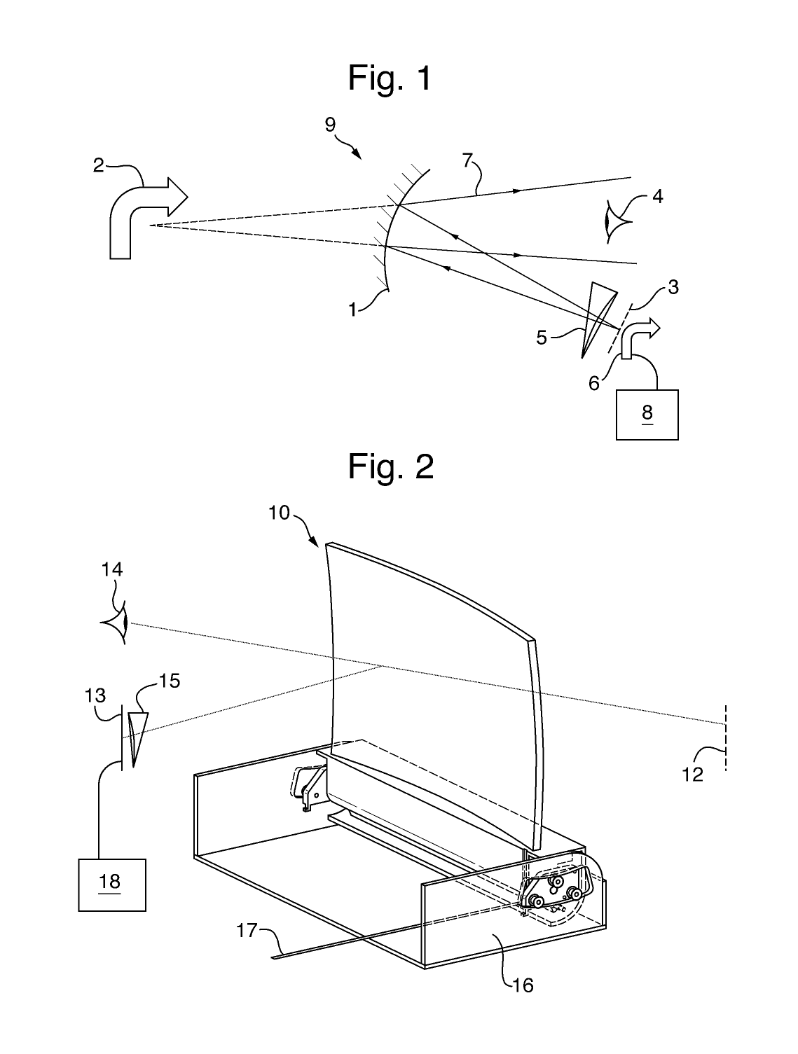

FIG. 1 shows a head up display schematic for a vehicle,

FIG. 2 shows a head up display device in a deployment device,

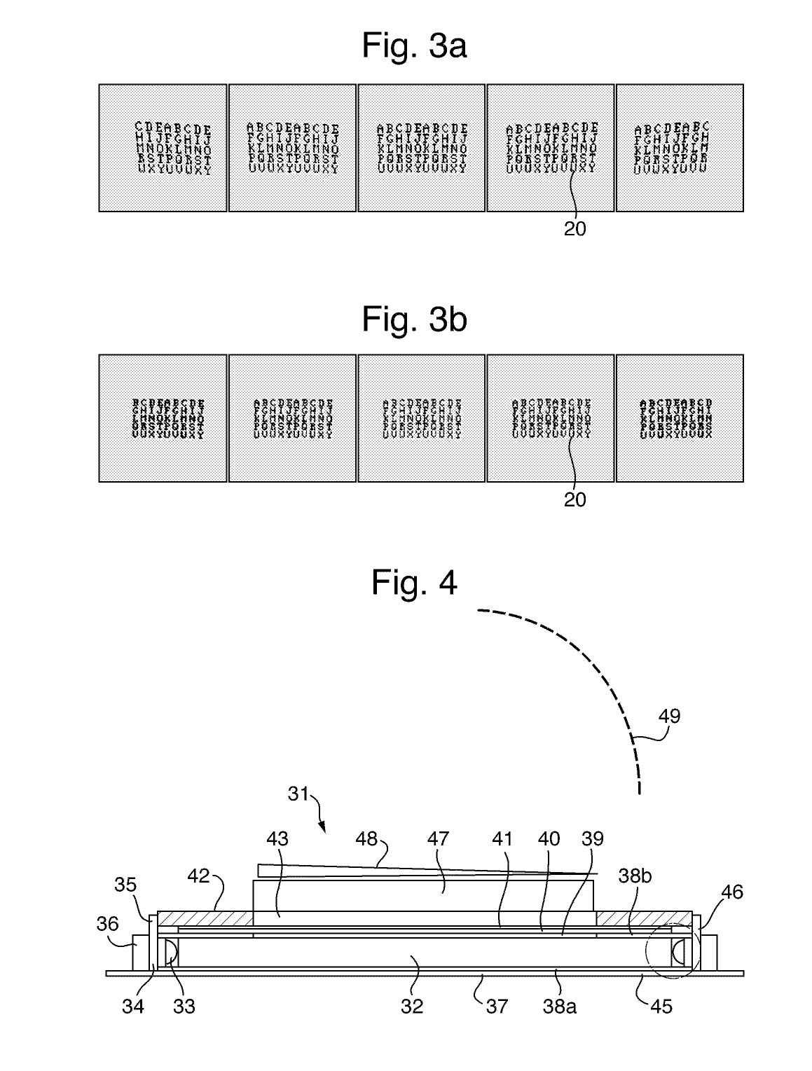

FIGS. 3a and 3b show the distorted image and compound prismatic lens corrected images,

FIG. 4 shows a side view of a backlight module, LCD display and prismatic lens,

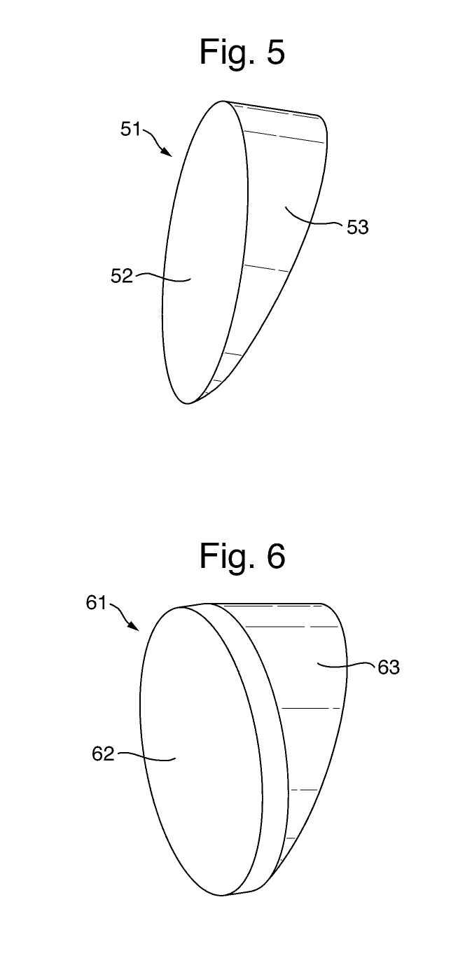

FIG. 5 shows an example of a compound prismatic lens,

FIG. 6 shows a further example of a compound prismatic lens.

Turning to FIG. 1, there is provided a display device 9, comprising a display 3, which provides an virtual image 2 to be displayed in the line of sight 7, of the user 4. The display 3 outputs an image 6 from the vehicle information system 8, such as, for example, a car dashboard, satellite navigation, or an entertainment system.

The display 3 projects the image 6 via a correcting lens, preferably a compound prismatic lens 5, the output of which is then directed to a partially reflective combiner(or windscreen) 1, which provides an active virtual image 2a, remote from the user 4, outside of the vehicle (not shown).

The use of a partially reflective combiner 1, may remove the requirement of using a vehicle windscreen as the partially reflective surface, and thus allows the display device 9 to be readily retrofitted to any vehicle, without prior consideration of the optical properties of the vehicle windscreen.

In FIG. 2 there is provided a HUD system 10 comprising a combiner 11 in a deployment housing 16. The combiner may be deployed to the active position as shown when in use, such that the user 14, is able to view a virtual image 12, which is caused by the display 13, projecting an image of the data from the vehicle information system 18, via the compound prismatic lens 15 on to the combiner. A draw cord 17 may be activated by a servomotor, to raise and lower the combiner 11. In the inactive position the combiner lies in a position which is substantially orthogonal to that shown.

Turning to FIG. 3a shows images of a double alphabet 20 generated by Zemax (optical modelling programme) as would be seen through a HUD. The aspect ratio of the image is 2:1 and represents a screen 41.1 mm wide with 480 pixels. From left to right the images represent horizontal eye positions at: −75 mm, −37.5 mm, 0 mm 37.5 and 75 mm. The centre of image will appear to be approximately 70 mm from bottom of a combiner. Maximum grid distortion for −37.5 mm eye position is −2.2%. The standard distortion merit function gives a value of 0.041.

FIG. 3b Images of the images in the Zemax model of a double alphabet 21 using a compound prismatic lens to correct the distortion. The maximum grid distortion for the −37.5 mm eye position is 1.9%. The standard distortion merit function gives a value of 0.008.

Turning to FIG. 4 there is provided a backlight module generally shown at 31. There are a plurality of illumination sources 46. The illumination source is formed from a heat sink 36, onto which is mounted a printed circuit board 35. The circuit 35 contains a plurality of LEDs 34, which have their output focused by means of a lens 33.

The illumination source 46 is located on three of the edges of a light guide plate 32. The lower surface of the light guide plate 32 is formed with a plurality of optical scattering dots and is encapsulated by at least one layer of a white reflector 38a, 38b. The lower white reflector layer 38a covers the entire lower face of the light guide plate 32. White reflectors 38a, 38b, reflects light back into the light guide plate. The upper white reflector layer 38b, has an optically transparent aperture 39 which allows the light from the light guide to leave the device. Located on top of the aperture 39, is a diffuser film 40, which further unifies the output luminance. Two orthogonally co-located brightness enhancement films shown generally at 41, are located on the diffusing plate 40. The final optical component is a display mask layer 42, with an optically transparent aperture 43, wherein the aperture 43 has substantially the same area as the LCD display 47 which is to be illuminated and projected.

The housing 45, is formed from a mounting plate 37, on which is located three sides of edge illumination sources 46.

The light projected from the backlight module 31 is passed through the LCD display 47, via prismatic lens 48 and further projected to a partially reflective combiner 49. The prismatic lens 48 is in optical connection to the display 47, this may be directly abutting the two together, or using an adhesive(not shown).

FIG. 5 shows a compound prismatic lens 51, formed from a positive lens 52 and a prism 53.

FIG. 6 shows a compound prismatic lens 61, formed from a negative lens 62 and a prism 63.

1. A display device for vehicles, comprising:
at least one display, which provides system information that is to be displayed to a user; and
a partially reflecting combiner, which magnifies the system information from the display, and provides a virtual image of said display;
wherein a distortion correcting lens is located between the display and said partially reflecting combiner.

2. A display according to claim 1 wherein the distortion correcting lens is selected from a tilted prism, a tilted negative focal length lens, and a compound prismatic lens.

3. A display according to claim 2, wherein the compound prismatic lens comprises a lens and prism.

4. A display according to claim 3, wherein said lens and prism are selected from materials with different dispersion functions.

5. A display according to claim 3, wherein the compound prismatic lens comprises a separate lens and prism abutted together.

6. A display according to claim 3, wherein the compound prismatic lens is configured as a single optic with a variable refractive index.

7. A display according to claim 2, wherein the distortion correcting lens is a positive or negative lens.

8. A display according to claim 3, wherein the lens and prism are selected such that lens V_{L} and the prism V_{P}, wherein V_{L}<V_{P}.

9. A display according to claim 3, wherein the lens has a high dispersion value and the prism has a low dispersion value.

10. A display according to claim 3, wherein the lens and prism are made from materials selected from glass or a plastic or a polymer.

11. A display according to claim 2, wherein the effective focal length of the compound prismatic lens is in the range of from −100 to 1000.

12. A display according to claim 2, wherein the apex angle of the tilted prism is in the range of from 10 to 30°.

13. A display according to claim 1, further comprising at least one fluidic lens located between the distortion correcting lens and said partially reflecting combiner, to provide an active primary virtual image.

14. A compound prismatic lens for providing chromatic aberration correction comprising a lens and prism, wherein said lens and prism are selected from materials with different dispersion functions.

15. A method of reducing keyhole distortion and chromatic aberration of a displayed image, comprising the steps of locating a lens according to claim 14, between a display and a partially reflective combiner.

16. A display device for vehicles, comprising:
at least one display, which provides system information that is to be displayed to a user;
a partially reflecting combiner, which magnifies the system information from the display, and provides a virtual image of said display; and
a distortion correcting lens comprising a compound prismatic lens configured as a single optic with a variable refractive index or with a lens and prism mated together,
wherein the compound prismatic lens is located between the display and said partially reflecting combiner.

17. A display device according to claim 16, wherein said lens and prism are selected from materials with different dispersion functions.

18. A display device according to claim 16, wherein the compound prismatic lens comprises a separate lens and prism abutted together.

19. A display device according to claims 16, wherein the compound prismatic lens is configured as a single optic with a variable refractive index.

20. A display device according to claim 16, further comprising at least one fluidic lens located between the distortion correcting lens and said partially reflecting combiner, to provide an active primary virtual image.
